(19) United States
(12) Patent Application Publication
(10) Pub. No.: US 2006/0117354 A1
(43) Pub. Date: Jun. 1, 2006

(54) Consolidating video-on-demand (VOD) services with multi-room personal video recording (MR-PVR) services

(76) Inventors: Mark Schutte, Suwanee, GA (US); Samuel Russ, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/998,879

(22) Filed: Nov. 29, 2004

(51) Int. Cl. H04N 7/18; H04N 7/173; H04N 7/16

(52) U.S. Cl. 725/78; 725/74; 725/142; 725/134; 725/89

(57) ABSTRACT

Various embodiments are described, in which multi-room personal video recording (MR-PVR) services and video-on-demand (VOD) services are integrated to provide a consolidated interface for a viewer to select among VOD services and MR-PVR services, among others. For some embodiments, both MR-PVR and VOD services can be accessed by a viewer through a single user interface. For other embodiments, clients that perform both PVR and VOD client-side functions are disclosed. For yet other embodiments, devices that perform the PVR server-side functions and VOD client-side functions are disclosed.

### CROSS-REFERENCE TO RELATED APPLICATIONS

This application incorporates by reference all of the following references, in their entireties:

U.S. patent application having Ser. No. 10/263,160, filed on Oct. 2, 2002, entitled “Systems and methods for providing television signals to multiple televisions located at a customer premises.”

U.S. patent application having Ser. No. 10/263,449, filed on Oct. 2, 2002, entitled “Expandable tuning capability.”

U.S. patent application having Ser. No. 10/403,485, filed on Mar. 31, 2003, entitled “Networked multimedia system having a multi-room interactive network guide,” which claims priority to U.S. provisional patent application having Ser. No. 60/416,155, filed on Oct. 4, 2002; is related to both U.S. patent application having Ser. No. 10/212,017, filed on Aug. 2, 2002 and U.S. patent application having Ser. No. 10/235,201, filed on Sep. 5, 2002; and incorporates by reference U.S. patent applications having Ser. Nos. 10/263,160, 10/263,449, and 10/263,270, which were all filed on Oct. 2, 2002.

U.S. patent application having Ser. No. 10/437,556, filed on May 14, 2003, entitled “Systems and methods for operating a peripheral record/playback device in a networked multimedia system,” which claims priority to U.S. provisional patent application having Ser. No. 60/418,412, filed on Oct. 15, 2002. U.S. patent application having Ser. No. 10/437,556 is also a continuation-in-part (CIP) of U.S. patent application having Ser. No. 10/342,670, filed on Jan. 15, 2003, which claims priority to U.S. provisional patent application Ser. No. 60/416,155, filed on Oct. 4, 2002. U.S. patent application having Ser. No. 10/437,556 is also a CIP of U.S. patent application having Ser. No. 10/403,485, filed on Mar. 31, 2003, which claims priority to U.S. provisional patent application having Ser. No. 60/416,155, filed on Oct. 4, 2002. U.S. patent application having Ser. No. 10/437,556 also incorporates by reference U.S. patent application having Ser. Nos. 10/263,160, 10/263,449, and 10/263,270, which were all filed on Oct. 2, 2002.

### FIELD OF THE DISCLOSURE

The present disclosure relates generally to data communications and, more particularly, to client-server data communications.

### BACKGROUND

Video-on-demand (VOD) services and other media-related services are well known in the art. For conventional VOD systems, such as that shown in FIG. 1A, a VOD client 105 (running inside a set-top terminal, for example) issues requests using quadrature phase shift keying (QPSK) or other known approaches. These requests are conveyed through a hybrid fiber-coaxial (HFC) network 115 to a VOD server 110, which processes the request in accordance with known methods.

As shown in FIG. 1B, the VOD server 110 packages the requested programming using quadrature amplitude modulation (QAM) or other known mechanisms, and transmits the requested programming back to the VOD client 105 through the HFC network 115. The VOD client 105, upon receiving the programming, demodulates the programming and plays it for the subscriber or viewer. In addition, if the VOD client 105 is equipped with a personal video recorder (PVR), the VOD client 105 demodulates the programming and saves it for future play.

A user interface 200, similar to that shown in FIG. 2, is typically displayed to the viewer, thereby enabling the viewer to choose from a selection of available titles 230 for VOD ordering. While the VOD user interface 200 (or other comparable user interface) provides a convenient approach to ordering VOD programming, the full potential of such a user interface 200 has yet to be utilized. Thus, a heretofore-unaddressed need exists in the industry.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a block diagram showing a client-server environment for video-on-demand (VOD) services, in which a VOD client requests VOD programming.

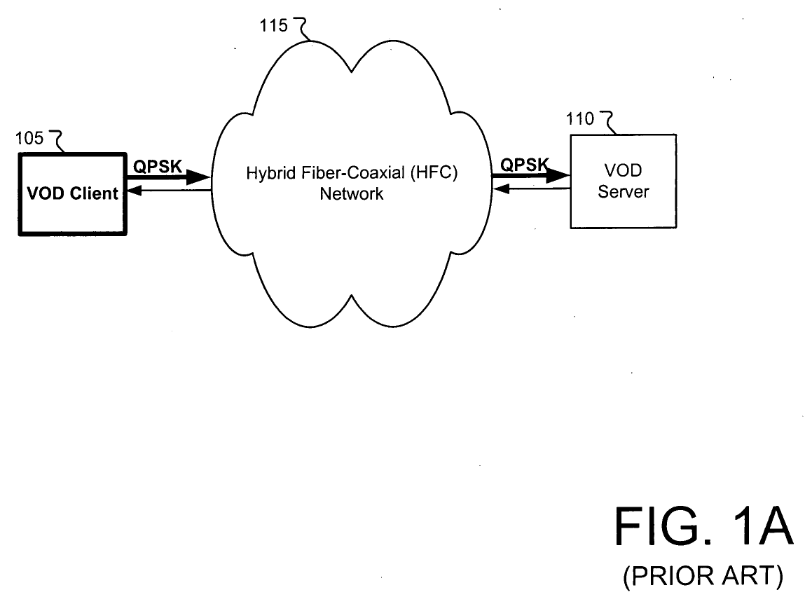

FIG. 1B is a block diagram showing a client-server environment for video-on-demand (VOD) services, in which a VOD server provides VOD programming.

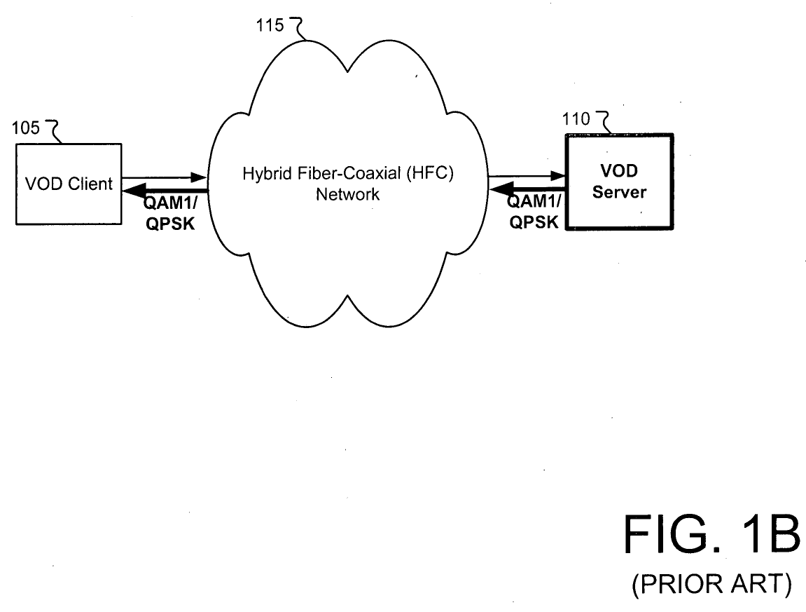

FIG. 2 is a block diagram showing an example user interface for VOD services.

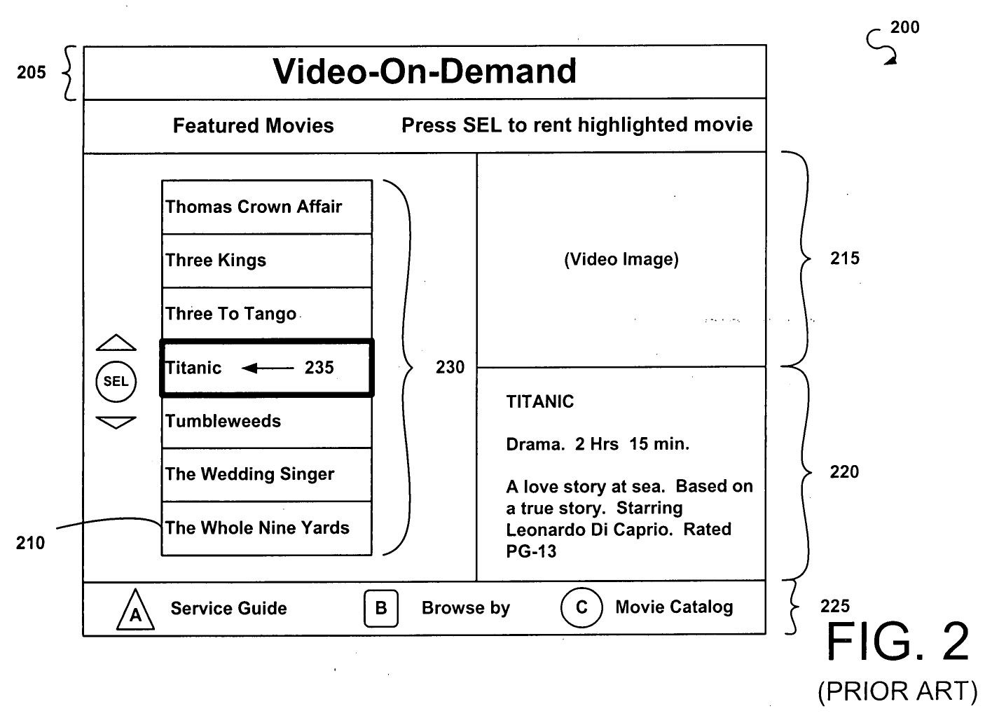

FIG. 3A is a block diagram showing a client-server environment that enables both VOD services and personal video recording (PVR) services, in which a VOD/PVR client requests VOD programming.

FIG. 3B is a block diagram showing a client-server environment that enables both VOD services and PVR services, in which a VOD server provides the VOD programming.

FIG. 4A is a block diagram showing a client-server environment that enables both VOD services and PVR services, in which the VOD/PVR client requests PVR programming.

FIG. 4B is a block diagram showing a client-server environment that enables both VOD services and PVR services, in which the PVR server provides the PVR programming.

FIG. 5 is a block diagram showing an embodiment of a user interface that enables both VOD programming requests and PVR programming requests.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

Video-on-demand (VOD) services, which are well known in the art, enable viewers to request various media services from an operator. The requested media services, such as movies, etc., are then provided to the viewer's set-top terminal (STT) for viewing. In the event that the STT includes a personal video recorder (PVR), the movie or other media content instance can be recorded on the PVR for later viewing. Of course, the PVR can also be used to record regularly broadcast media content instances.

The PVR can be used in a multi-room (MR) setting, as described in the cross-referenced patent applications. In that regard, if the viewer has a television (TV) in different rooms at the viewer's location (e.g., home, office, etc.), then each of the TVs at the viewer's location can access the PVR, thereby enabling MR-PVR. Since MR-PVR environments, as well as systems and methods related to MR-PVR, are discussed in greater detail in the cross-referenced applications, only a truncated discussion of MR-PVR is provided below.

The various embodiments, disclosed herein, provide approaches in which MR-PVR services and VOD services are integrated to provide a consolidated interface for a viewer to select either VOD services or MR-PVR services.

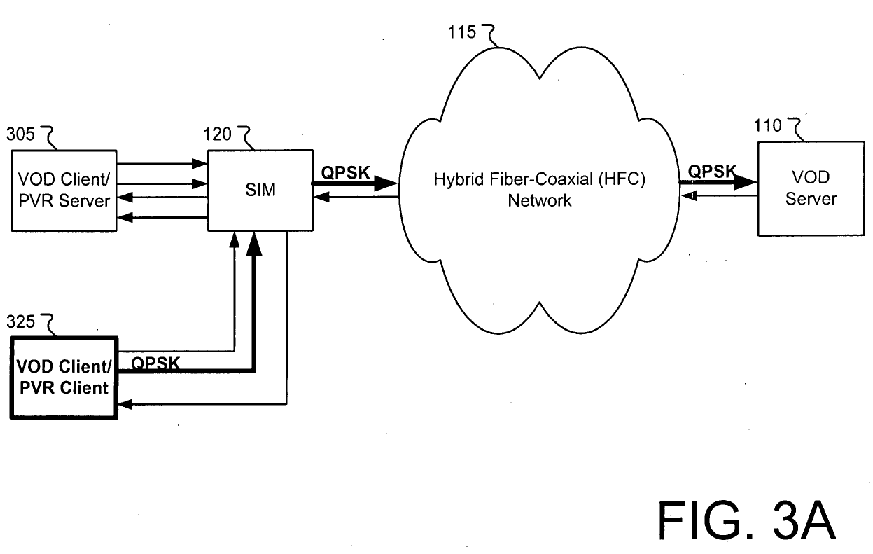

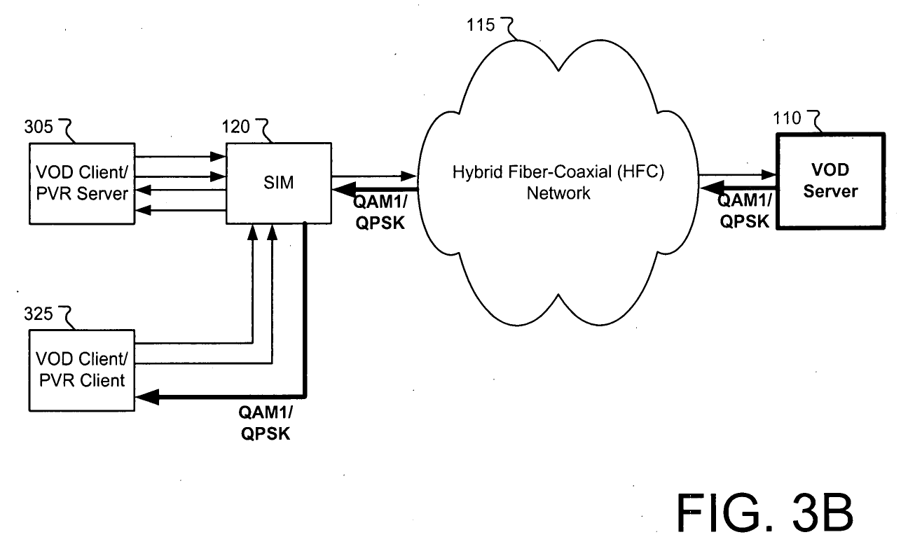

FIG. 3A is a block diagram showing a client-server environment that enables both VOD services and PVR services. As shown in FIG. 3A, an embodiment of a consolidated VOD/MR-PVR environment includes a VOD server 110 that is coupled to a hybrid fiber-coaxial (HFC) network 115. A viewer's location, which is interfaced to the HFC network 115 through a splitter isolation module (SIM) 120, is located on the other side of the HFC network 115 from the VOD server 110.

The viewer's location includes multiple VOD clients 305, 325, each of which also functions within as a component in the MR-PVR environment. At least one VOD client 305 selectively acts as a PVR server 305, which in some embodiments includes separate logic for performing the PVR server functions. In that regard, that component is labeled VOD client/PVR server 305, since it in essence performs both the role of a VOD client as well as the role of a PVR server. Another VOD client 325 may act as a PVR client 325. In that regard, that component is labeled VOD client/PVR client 325, since it performs both the role of a VOD client as well as the role of a PVR client. It should also be understood that clients 305, 325 are further representative of STTs including additional components for providing STT functionality, as would be understood by those skilled in the art, including with additional reference to the cross-referenced applications. For example, PVR client functionality could also be included with VOD client/PVR server 305 for providing conventional PVR functionality.

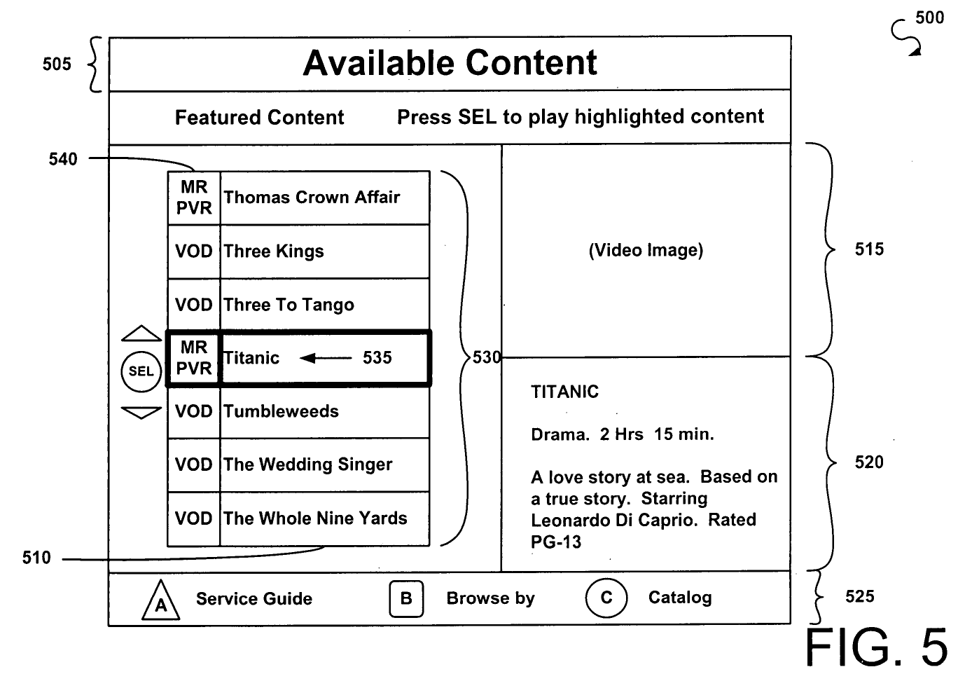

Insofar as the VOD client/PVR client 325 performs the client function for both VOD and MR-PVR services, in some embodiments, among others, a single user interface can be implemented to provide access to both the VOD services as well as the MR-PVR services. An embodiment of such a user interface 500 is shown in FIG. 5. Since both VOD and MR-PVR services are available through this interface 500, the interface is simply labeled “Available Content” 505. The user interface 500 is configured to display a combined list of VOD movies as well as a list of MR-PVR recordings. This content list is compiled and created from lists of movies and recordings that are stored on the VOD server 110 and the MR-PVR server 305, respectively. The list of VOD movies can be compiled using conventional VOD approaches. Similarly, the list of MR-PVR recordings can be compiled the approach described in the cross-referenced patent applications. An aggregate list of all content can then be rendered and displayed at the user interface using, for example, known rendering and displaying techniques.

As shown in FIG. 5, the user interface 500 includes various user-selectable icons, such as, for example, featured content 530 and guide options 525. The guide options 525 include items, such as, for example, a “service guide” A, a “browse by” category B, and a “catalog” C, among others. The featured content 530 are provided in list fashion, with each of the content instances being selectable by a viewer.

Since both VOD and MR-PVR content are available through this interface, the listed content instances include an indicator 540, which identifies the particular content instance as being either a VOD selection or a MR-PVR selection. For example, in the embodiment of FIG. 5, the movie “Titanic” 535 is labeled as a MR-PVR selection, while the movie “Three Kings” is labeled as a VOD selection. In addition to these icons, the VOD selections can also include additional information, such as, for example, a cost associated with ordering a particular selection. In some embodiments, the cost information can be displayed at a summary panel 520, which provides detailed information related to a particular VOD service. Particularly, as shown in FIG. 5, the summary panel 520 includes specific information related to the movie “Titanic,” which is selected from the featured movies 530 list.

In operation, a viewer navigates through the user interface 500 using a remote controller or a front-panel interface, such as those known in the art. If the user wishes to scroll down the list of featured content 530, the user can do so with scroll icons that are provided on the user interface. Since scroll icons and their operations are known in the art, further discussion of scroll icons is omitted here. Upon scrolling to a desired selection, such as, for example, “Titanic” 535, the viewer can select the content instance using the “SEL” icon, as shown in FIG. 5. Since such icons and their respective functions are known in the art, further discussion of the SEL icon is omitted here.

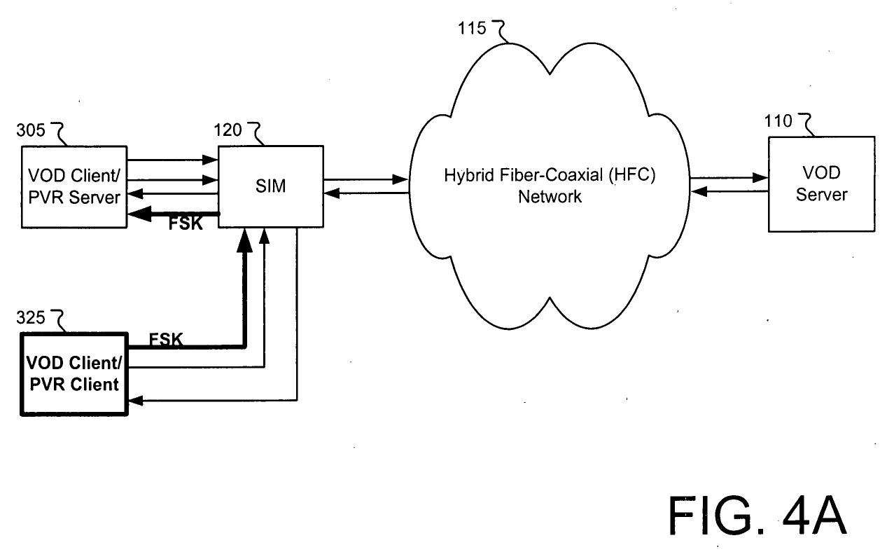

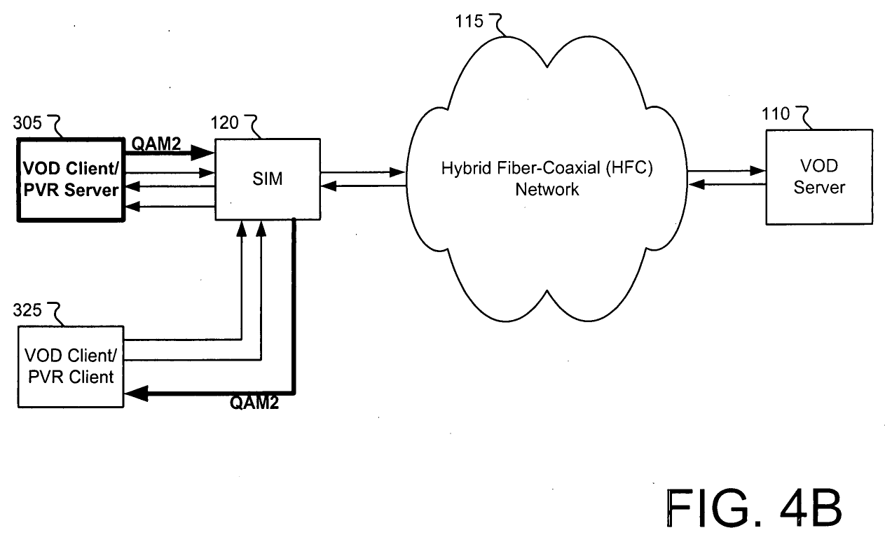

If the selected service is a VOD movie, then the VOD client/PVR client 325 retrieves the VOD movie from a VOD server, as shown in FIGS. 3A and 3B. Alternatively, if the selected service is a MR-PVR recording, then the VOD client/PVR client 325 retrieves the MR-PVR movie from a PVR server, as shown in FIGS. 4A and 4B.

As shown in FIG. 3A, when a viewer selects a VOD movie from the list of content 530, then the VOD client/PVR client 325 receives that input through input-receive logic (not shown). Upon receiving the selection of a VOD movie, a request is generated by the VOD client/PVR client 325. That request is then transmitted to the VOD server 110 through a quadrature phase shift keying (QPSK) transmitter.

The VOD server 110 receives the QPSK request and retrieves the corresponding VOD service or movie. For example, if the request is for the movie “Three Kings,” then the VOD server 110 retrieves the movie “Three Kings” in response to the request.

As shown in FIG. 3B, the service or movie is then transmitted by the VOD server 110 using quadrature amplitude modulation (QAM) techniques, which are known in the art. Specifically, a frequency band between approximately 54 MHz to approximately 860 MHz is employed for the VOD QAM, shown in FIG. 3B as QAM1. As is known in the art, since the SIM has a notch filter at approximately 873 MHz, the VOD QAM signal can freely pass through the SIM 120.

In addition to the QAM1 signal, the VOD server 110 can also provide control or authorization information to the VOD client/PVR client 325 using QPSK. Since downstream VOD communications are known in the art, further discussion of VOD downstream communications is omitted here.

The VOD client/PVR client 325 receives the movie, which is transmitted using QAM1, through its QAM receiver. The movie or service is then displayed to the viewer at the VOD client/PVR client 325. Thus, as shown with reference to FIGS. 3A and 3B, the VOD client-server interaction can be implemented using conventional VOD techniques.

As described in the cross-referenced patent applications, the MR-PVR server stores various movies or other content, which have been previously recorded. Additionally, the MR-PVR server provides a list of all recordings.

As shown in FIG. 4A, if a viewer selects an MR-PVR content instance, which is stored on the MR-PVR server 305, then the VOD client/PVR client 325 receives an input that is indicative of the selection through input-receive logic (not shown). Upon receiving the selection of an MR-PVR recording, a request is generated by the VOD client/PVR client 325. That request is then transmitted to the VOD client/PVR server 305 through a frequency shift keying (FSK) transmitter.

For some embodiments, that request may include commands, such as, for example, play, fast-forward, rewind, skip, or other known commands that are comparable to known VOD commands or known PVR commands.

The VOD client/PVR server 305 receives the FSK request and retrieves the corresponding MR-PVR recording from its storage medium. For example, if the request is to play the movie “Titanic,” then the VOD client/PVR server 305 retrieves the movie “Titanic” in response to the request, and plays the movie over the network. Similarly, if the request were to pause a movie during viewing, then the VOD client/PVR server 305 would pause the movie in response to the request.

As shown in FIG. 4B, the recorded content instance (recording) is then transmitted by the VOD client/PVR server 305 using QAM techniques, which are known in the art. However, unlike the VOD server 110 of FIG. 3B, the VOD client/PVR server 305 employs a frequency band of 873 MHz for its QAM (referred to herein as “QAM2”), which is the frequency of the notch filter in the SIM 120. In that regard, the SIM 120 confines the QAM2 signal to within the customer premises.

The VOD client/PVR client 325 receives the recording, which is transmitted using QAM2, through its QAM receiver. The recording is then demodulated and displayed to the viewer at the VOD client/PVR client 325. For example, if the request were to play the recording, then the recording would be played at the VOD client/PVR client 325. Alternatively, if the viewer issues a pause command while viewing the recording, then the recording would be paused at the VOD client/PVR client 325.

As described above, by providing a consolidated interface for both VOD and MR-PVR services, a viewer can seamlessly request either VOD services or MR-PVR services with a single user interface, rather than having to utilize multiple user interfaces for each service. Also, by providing services that correspond to the VOD services within the MR-PVR environment, a viewer can readily utilize both VOD and MR-PVR functions from a single client location an interface, thereby increasing use of paid VOD services. Furthermore, by employing a distinct QAM bandwidth for VOD (e.g., approximately 54 MHz to approximately 860 MHz) and a different QAM bandwidth for MR-PVR (e.g., approximately 873 MHz), the environment enable the isolation of MR-PVR signals to within the viewer's location while also enabling pass-through of VOD signals to the viewer's location.

It should be appreciated that various functions of both the VOD client/PVR server 305 and the VOD client/PVR client 325 can be implemented in hardware, software, firmware, or a combination thereof. In the preferred embodiment(s), the various functions are implemented in software or firmware that is stored in a memory and that is executed by a suitable instruction execution system. If implemented in hardware, as in an alternative embodiment, the various functions can be implemented with logic components that are reflective of their various functions (e.g., list-receive logic to receive a list of programs, render logic to render the list of programs, input-receive logic to receive a selection input from a viewer, request logic to generate a request, transmit logic to transmit requests, media-receive logic to receive a requested service or movie, display logic to display a service or movie, etc.). These logic components can be implemented using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The VOD client functions, the PVR client functions, and the PVR server functions can be implemented through appropriate computer programs, which comprise an ordered listing of executable instructions for implementing logical functions. Such programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured via, for instance, optical scanning of the paper or other medium, then compiled, interpreted or otherwise processed in a suitable manner if necessary, and then stored in a computer memory.

Although exemplary embodiments have been shown and described, it will be clear to those of ordinary skill in the art that a number of changes, modifications, or alterations to the disclosure as described may be made. For example, while QPSK and FSK have explicitly been recited for some embodiments, it should be appreciated that other known or future-developed modulation techniques can be used for the generation of requests. Similarly, other techniques can be used to distinguish between MR-PVR requests and VOD requests. Similarly, while QAM is used to illustrate a technique for providing movies or other services from the server-side, it should be appreciated that other modulation techniques can be substituted without detriment to the scope of the disclosure.

Also, it should be appreciated that the requested services or movies can be replayed at their respective client locations in near real time. Alternatively, the services or movies can be buffered and temporarily stored at the client location, thereby enabling more robust play. As another alternative, it should be appreciated that the services or movies can be recorded at the client location for future play.

All such changes, modifications, and alterations should therefore be seen as within the scope of the disclosure.

What is claimed is:

1. A user interface generated from computer-readable media comprising:
a video-on-demand (VOD) icon associated with a user-selectable area; and
a multi-room personal video recorder (MR-PVR) icon associated with the user-selectable area.

2. The user interface of claim 1, wherein the VOD icon includes an indication of a VOD service.

3. The user interface of claim 2, wherein the VOD icon includes cost associated with the VOD service.

4. The user interface of claim 1, wherein the MR-PVR icon includes an indication of a MR-PVR service.

5. A device comprising:
a video-on-demand (VOD) client located on the device; and
a multi-room personal video recorder (MR-PVR) server located on the device.

6. The device of claim 5, the VOD client comprising:
list-receiver logic adapted to receive a list of VOD programs from a VOD server; and
render logic adapted to render the list of VOD programs for display at a user interface.

7. The device of claim 6, the VOD client further comprising:
input-receiver logic adapted to receive an input from a viewer at the user interface, the input being indicative of a selection from the list of VOD programs;
request logic adapted to generate a request in response to receiving the request from the viewer; and
transmit logic adapted to transmit the request to the VOD server.

8. The device of claim 7, the transmit logic further being adapted to transmit the request using quadrature phase shift keying (QPSK).

9. The device of claim 7, the VOD client further comprising:
media-receiver logic adapted to receive a media program from the VOD server, the media program being correlated to the selection from the list of VOD programs; and
display logic adapted to display the media program for the viewer.

10. The device of claim 9, the media-receive logic further being adapted to receive the media program from the VOD server using quadrature amplitude modulation (QAM).

11. The device of claim 5, the MR-PVR server comprising a storage medium, the storage medium having a MR-PVR program.

12. The device of claim 11, the MR-PVR server further comprising receiver logic adapted to receive a request for the MR-PVR program stored on the storage medium.

13. The device of claim 12, the receive logic further being adapted to receive the request using frequency shift keying (FSK).

14. The device of claim 12, the MR-PVR server further comprising media-transmit logic adapted to transmit the MR-PVR program to a MR-PVR client in response to receiving the request.

15. The device of claim 14, the media-transmit logic further being adapted to transmit the MR-PVR program using quadrature amplitude modulation (QAM).

16. A device comprising:
a video-on-demand (VOD) client located on the device; and
a multi-room personal video recorder (MR-PVR) client located on the device.

17. The device of claim 16, further comprising:
VOD list receive logic adapted to receive a list of VOD programs from a VOD server; and
MR-PVR list receiver logic adapted to receive a list of MR-PVR programs from a MR-PVR server.

18. The device of claim 17, further comprising render logic adapted to render a user-selectable VOD icon for display at a user interface, the user-selectable VOD icon representing a VOD program from the list of VOD programs, the render logic further being adapted to render a user-selectable MR-PVR icon for display at the user interface, the user-selectable MR-PVR icon representing a MR-PVR program from the list of MR-PVR programs.

19. The device of claim 18, further comprising:
input-receiver logic adapted to receive an input using the user interface, the input being one selected from:
a selection of the user-selectable VOD icon; and
a selection of the user-selectable MR-PVR icon;
request logic adapted to generate a request in response to receiving the input.

20. The device of claim 19, further comprising:
a quadrature phase shift keying (QPSK) transmitter adapted to transmit the request to the VOD server in response to the input being the selection of the user-selectable VOD icon; and
a frequency shift keying (FSK) transmitter adapted to transmit the request to the MR-PVR server in response to the input being the selection of the user-selectable MR-PVR icon.

21. The device of claim 20, further comprising:
media-receiver logic adapted to receive a media program, the media program being correlated to the input; and
display logic adapted to display the media program.

22. The device of claim 21, the media-receive logic further being adapted to receive the media program using quadrature amplitude modulation (QAM).

23. The device of claim 20, further comprising:
means for receiving a media program, the media program being correlated to the input; and
means for displaying the media program.
